(19) United States
(12) Patent Application Publication
(10) Pub. No.: US 2009/0057131 A1
(43) Pub. Date: Mar. 5, 2009

(54) DIRECT INJECTION OF PLASMA ACTIVATED SPECIES (PAS) AND RADIATION INTO LIQUID SOLUTIONS ASSISTED WITH BY A GAS BUFFERED HOUSING

(76) Inventors: VLADIMIR TARNOVSKY, Fair Lawn, NJ (US); WEIDONG ZHU, North Arlington, NJ (US)

Correspondence Address: GREENBERG TRAURIG, LLP, 200 PARK AVE., P.O. BOX 677, FLORHAM PARK, NJ, 07932, US

(21) Appl. No.: 12/201,229

(22) Filed: Aug. 29, 2008

Related U.S. Application Data
(60) Provisional application No. 60/969,326, filed on Aug. 31, 2007.
(60) Provisional application No. 61/128,675, filed on May 23, 2008.

(51) Int. Cl. H05F 3/06

(52) U.S. Cl. 204/164

(57) ABSTRACT

A method of stimulating chemical reactions within a liquid uses a gas plasma ejected from a gas-buffered plasma injection device to create a plasma-liquid interface. The injection device has an electrically-conductive housing with an inlet, an outlet and an electrode embedded in the housing interior so as to create flow paths through the electrode and between the electrode and housing, in the method, the outlet is submersed in a liquid and a gas plasma is supplied at the inlet. A direct-current voltage applied across the electrode and housing accelerates the plasma and ejects it through the outlet into the liquid.

### CROSS-REFERENCE TO RELATED APPLICATIONS

This application claims benefit of U.S. Provisional Patent Application No. 60/969,326, filed Aug. 31, 2007, and U.S. Provisional Patent Application No. 61/128,675, filed May 23, 2008, the disclosures of which are incorporated herein by reference.

### FIELD OF THE INVENTION

The present invention relates to the fields of plasma generation and chemistry.

### BACKGROUND OF THE INVENTION

Currently, the interactions between non-thermal plasma (NTP) and liquid media are mainly utilized in water treatment. Such interactions are usually accomplished by the direct discharge of water and water plasma using various methods. Other approaches involve generating a direct current/alternating current discharge through a water/water vapor interface, or through gas bubbles. These approaches, however, require high voltage pulses, with a corresponding high power consumption, and are limited by their low operating volumes.

### SUMMARY OF THE INVENTION

A non-thermal plasma (NTP)-liquid interface is generated using a gas-buffered housing having a gas inlet and nozzle, and a gas discharge plasma reactor. Gas is made to flow through or around the gas discharge plasma volume so as to create a gas pressure inside the housing that is greater than the overall pressure at exit of the nozzle, including the pressure due to depth of the liquid media and the pressure above the liquid. Under such conditions, the plasma inside the housing is sustained and the plasma activated species (PAS) is injected directly into the liquid via the nozzle. The chemical reaction of PAS with liquid effectively occurs at the surface of the gas cavity around the nozzle and on the surfaces of micro-liquid droplets that exist within the gas cavity.

The present invention provides a simple and convenient NTP-liquid interface system for the direct injection of PAS into liquid, thus improving the overall efficiency of the plasma-liquid interaction. The invention has a simple construction, is compact and can be operated in a safe, clean and scalable way.

### BRIEF DESCRIPTION OF FIGURES

FIG. 1 is a schematic diagram of the creation of a plasma-liquid interface using a gas-buffered housing according to the invention.

FIG. 2 is a schematic diagram of a second gas-buffered housing according to the invention.

### DETAILED DESCRIPTION OF THE INVENTION

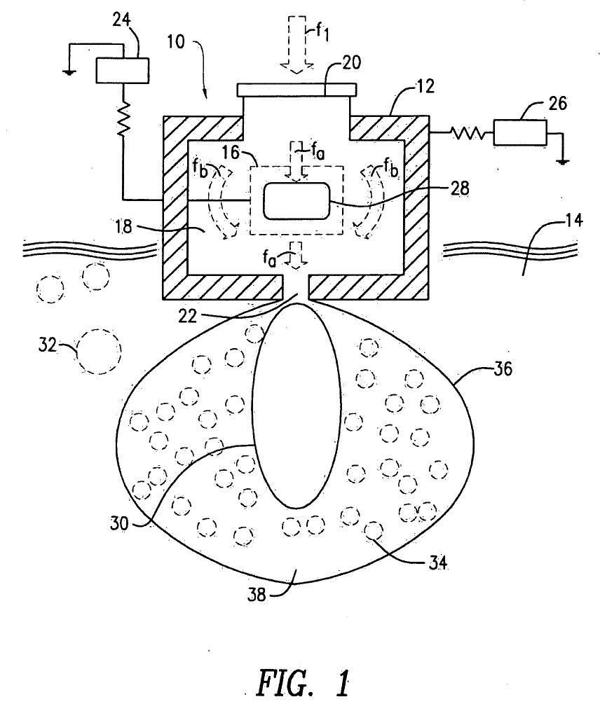

FIG. 1 is a schematic diagram illustrating the general concept of using a plasma injection device 10 having a gas-buffered housing 12 to inject plasma-activated species (PAS) into a liquid 14. The plasma-injection device 10 comprises the gas-buffered housing 12, which is electrically conductive, an embedded electrode 16, an electrical insulator (or dielectric) 18, a gas inlet 20, and a gas outlet 22, which, preferably, is a nozzle. The effective diameter of the gas outlet 22 will typically be on the order of 1 mm. The housing 12 and the embedded electrode 16 are electrically biased to act as anode and cathode, which may be achieved by connecting them to separate direct current (DC) power sources 24 and 26, respectively, or by connecting the embedded electrode 16 to the DC power source 24 and the housing 12 to ground. In the illustrated device 10, the insulator 18 is the gas itself, although any suitable dielectric material may be used. Arrow f₁ indicates a gas plasma entering the housing 12. Arrows fₐ indicate the flow of gas plasma through the electrode 16 and arrows f_{b} indicate the flow of gas plasma around the electrode 16 and surrounding a volume of discharge plasma 28. A plume 30 of PAS driven by the flow of gas f₁ is shown exiting the gas outlet 22. In concept, the source of the plasma is not critical to the invention, and a non-thermal gas plasma (NTP) may be used.

When the gas outlet 22 is submerged into the liquid 14, gas should be provided at the inlet 20 so as to maintain the pressure in the housing 12 equal to or higher than the overall pressure (pressure from the liquid solution 14 above the gas outlet 22 and the pressure above the liquid 14) at the gas outlet 22, so that liquid 14 does not flood the housing 12 through the gas outlet 22 and the discharge plasma 28 in the housing 12 is sustained. The housing 12 expels gas as a mixture of inflow gas and PAS. The PAS interacts with the liquid 14 on the surfaces of gas bubbles 32 expelled from the gas outlet 22. Moreover, micro-liquid droplets 34 that exist in the gas bubbles 32 and, especially, the gas-liquid interface 36 at the quasi-steady gas cavity 38 formed at the gas outlet 22 cause a tremendous increase of the surface area available for chemical reactions, leading to a much higher efficiency of conversion of the chemical species in the liquid 14.

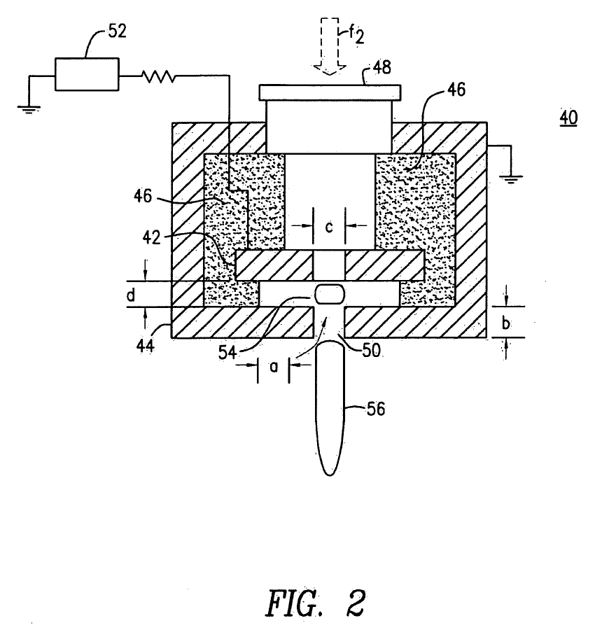

FIG. 2 illustrates a type of plasma injection device known as a microhollow cathode discharge (MHCD) structure 40. The MHCD of FIG. 2 has an embedded electrode 42, an electrically-conductive housing 44, a ceramic insulator (or dielectric) 46, arranged to provide gas flow paths (not shown) through and around the electrode 42, a gas inlet 48, and a gas outlet 50. The embedded electrode 42 is connected to a source of direct current (DC) voltage 52 and the housing 44 is electrically grounded. MHGDs, in general, are discussed in U.S. Pat. No. 6,433,480, which is incorporated herein by reference.

The cup-like housing 44, whether grounded or electrically biased, acts as the gas-buffered housing, which will also be referenced herein by the numeral 44. A NTP discharge plasma 54 is generated separately in a plasma reactor (not shown) and enclosed in the gas-buffered housing 44. Any electrically-isolated cup-like structure within or outside of the MHCD may perform as a gas-buffered housing 44, as long as it is electrically isolated from the plasma reactor and allows gas flow to exit through the gas outlet 50. The gas-buffered housing 44 may be integral to the plasma reactor. Gas plasma flow f₂ into the housing 44 can be maintained through the gas inlet 48. FIG. 2 also shows a resulting plume 56 of PAS being ejected from the housing 44.

For a series of experiments, a NTP-liquid interface system was constructed with a gas-buffered housing 44 integrated with a plasma reactor. A DC micro-discharge plasma 54 was generated using the MHCD 40 having a metal-dielectric-metal structure with a millimeter-size hole penetrating all of the structural layers. The thickness of the dielectric layer 46 was controlled to be less than 1 mm so that the dielectric 46 would readily break down at high gas pressures. The electrically-grounded gas-buffered housing 44 was integrated with the anode of the plasma reactor, so that the gas discharge plasma 54 would be placed at the gas outlet 50 of the housing 44.

Various gasses (air, O₂, N₂, Ar, Ne, He, and mixtures of such gasses) were used as the working gas and the gas flowing through housing 44. The PAS was carried by the gas and directly injected into a liquid (such as tap water, de-ionized water, bio-enriched water, methanol, oil, etc.) through gas outlet 50. When operated in ambient air, the clear plasma plume 56 (i.e., afterglow) was present which showed very little change when the gas outlet 50 was submerged into liquid.

The arrangement of the electrical circuit allowed almost 80% of the power from the power supply 52 to dissipate on the plasma discharge, improving the overall efficiency of the process. The voltage within the flow of PAS and electromagnetic radiation at the gas outlet 50 was measured to be up to 25 V with respect to electrical ground. A negative ion current of 1 mA to 1 nA was detected at distances ranging from 0.1 cm up to 20 cm from the gas outlet 50.

When air was used as working gas, direct oxidation of water was achieved in an extremely efficient way without discharging the water itself through the gas outlet 50. The hydrogen peroxide (H₂O₂) production rate was at least three times better from the best existing plasma-solution interaction method known to the inventors (i.e., capillary discharge in water, as discussed in Nikiforov; A. Yu., and Leys, C, “Influence of capillary geometry and applied voltage on hydrogen peroxide and OH radical formation in AC underwater electrical discharges”, Piasma Sources Sci. Technol. 16 (2007) 273-280, the disclosure of which is incorporated herein by reference).

The gas flow rate into the gas-buffered housing 44 is closely related to the diameter “a” and depth “b” of the gas outlet 50, the pressure above the liquid 14 and the depth to which the gas outlet 50 is submerged. The effectiveness of the injection of PAS into liquid depends on the diameter “a” and depth “b” of the gas outlet 50, the distance from the plasma reactor to the gas outlet 50, and the flow rate of the gas into the liquid 14.

A combination of two NTP-liquid interface systems may be opposed to each other with one gas-buffered housing biased positively to serve as a virtual anode and the other biased negatively to serve as a virtual cathode. With a flow of gasses from both systems, a gas discharge may be sustained within a quasi-steady state gas cavity generated between the opposing gas outlets.

Although the invention has been described and illustrated in detail, the following, non-limiting, experimental example may be useful to further illustrate application of the invention.

### EXPERIMENTAL EXAMPLE

### H₂O₂ Production in De-Ionized Water with Ambient Air as the Working Gas

PAS generation: PAS was generated via a MHCD structure, similar to that shown in FIG. 2, integrated with a plasma reactor. Direct current high voltage was supplied to the embedded electrode 42 at 20 mA. The grounded, metal gas-buffered housing 44 served as the other electrode. Ambient air was delivered into the air pressure plasma generator with an air compressor. The compressed air subsequently flowed through the openings in the electrodes 42, 44, where it was discharged within the high electric field created between the two electrodes 42, 44, pushing some of the PAS out of the gas outlet 50.

Introducing PAS into de-ionized water: The apparatus described above was set to create PAS continuously. As the apparatus was held stationary in a vertical position, a beaker containing 100 ml of de-ionized water was raised towards the gas outlet 50 of the gas-buffered housing 44 through a z-stage until the outer surface of the gas outlet 50 was about 2 cm below the surface of the de-ionized water. The flow of ambient air was controlled at a constant rate of about 30 ml/s and allowed to bubble out of the gas outlet 50. The PAS was introduced into the water continuously for about 15 minutes.

Measurement of the H₂O₂ concentration: The concentration of H₂O₂ in the treated water sample was evaluated using a HACH® hydrogen peroxide test kit (Model HYP-1; HACH Company, Loveland, Colo., USA). Ammonium molybdate solution was added to the treated de-ionized water sample, followed by the addition of HACH® Sulfite 1 reagent powder. After mixing, the color of the sample turned into a dark blue that was almost black. After 5 minutes, about 1 ml of the prepared sample was collected, and sodium thiosulfate titrant was added drop by drop until the color disappeared completely. Each drop of sodium thiosulfate titrant was counted as 1 mg/L of H₂O₂.

The H₂O₂ test showed that about 80 mg of H₂O₂/L of de-ionized water was produced during 15 minutes of direct introduction of PAS. This amount of H₂O₂ produced in similar tests would be dependent on air flow rate and electrical current.

pH test: The pH of the treated de-ionized water was tested using a standard pH paper test strip. No obvious color change is observed in tests made on the treated sample, indicating that there was no discernable deviation from the initial liquid pH of 7.

Ion current measurement outside of the gas outlet: The apparatus described above was held vertically, with ambient air as the working gas. Air flow and electrical current were maintained at about 30 ml/s and about 20 mA, respectively. An aluminum plate was connected to an ammeter to detect the ion current outside of the gas outlet 50. The distance of the surface of the aluminum plate from the outer surface of the gas outlet 50 was varied from 0.1 cm to 20 cm. The detected negative ion current was observed to decay with increased distance and ranged from 1 mA at a distance of 0.1 cm to 1 nA at 20 cm.

It should be understood that the embodiments described herein are merely exemplary and that a person skilled in the art may make many variations and modifications thereto without departing from the spirit and scope of the present invention. All such variations, and modifications, including those discussed above, are intended to be included within the scope of the invention, which is described, in part, in the claim presented below.

What is claimed is:

1. A method of stimulating chemical reactions within a liquid using a plasma-generating means for generating a gas plasma, a source of direct-current voltage, and a gas-buffered plasma injection device including an electrically-conductive housing having a hollow interior, a gas inlet opening through an end of said housing so as to communicate with said interior, a gas outlet opening through another end of said housing so as to communicate with said interior and having an effective diameter of about 1 millimeter, and an electrode having a hole therethrough with an effective diameter on the order of about 1 millimeter, said electrode being electrically isolated from said housing and embedded within said interior so as to create flow paths through said electrode and between said electrode and said housing, said plasma injection device being electrically isolated from said plasma-generating means, said method comprising the steps of:
electrically connecting said source of direct-current voltage to said electrode;
electrically grounding said housing or electrically connecting said housing to another source of direct-current voltage;
submersing said gas outlet in a liquid;
generating a gas plasma;
providing the gas plasma at said gas inlet at a rate sufficient to maintain a pressure within said interior of said housing that is greater than the pressure exerted by the liquid at said gas outlet; and
applying a direct-current voltage across said electrode and said housing, thereby accelerating said gas plasma so as to eject said gas plasma from said interior through said gas outlet and into the liquid so as to create a plasma-liquid interface.
